(19) United States
(12) Patent Application Publication
(10) Pub. No.: US 2008/0172716 A1
(43) Pub. Date: Jul. 17, 2008

(54) IP network vulnerability and policy compliance assessment by IP device analysis

(76) Inventors: Rajesh Talpade, Madison, NJ (US); Sanjai Narain, Madison, NJ (US); Yuu-Heng Cheng, Piscataway, NJ (US); Alexander Poylisher, Brooklyn, NY (US)

Correspondence Address: TELCORDIA TECHNOLOGIES, INC., ONE TELCORDIA DRIVE 5G116, PISCATAWAY, NJ, 08854-4157, US

(21) Appl. No.: 11/900,674

(22) Filed: Sep. 12, 2007

Related U.S. Application Data
(60) Provisional application No. 60/843,894, filed on Sep. 12, 2006.

(51) Int. Cl. G06F 17/00

(52) U.S. Cl. 726/1

(57) ABSTRACT

Customizable software provides assurances about the ability of an IP network to satisfy security, regulatory and availability requirements by comprehensive vulnerability and compliance assessment of IP networks through automated analysis of configurations of devices such as routers, switches, and firewalls. The solution comprises three main approaches for testing of IP device configurations to eliminate errors that result in vulnerabilities or requirements compliance issues. The first two fall in to the “static constraint validation” category since they do not change significantly for each IP network, while the last approach involves incorporation of each specific IP network's policies/requirements. These approaches are complementary, and may be used together to satisfy all the properties described above. The first approach involves checking the configurations of devices for conformance to Best-Current-Practices provided by vendors (e.g. Cisco Network Security Policy) and organizations such as the NIST, NSA or CERT. Also this includes checks of compliance with regulations such as FISMA, SOX, HIPPA, PCI, etc. The second approach is where as one reads device configurations, one collects beliefs about network administrator intent. As each belief is collected, an inference engine checks whether the new belief is inconsistent with previously accumulated beliefs. The third approach addresses the multiple device/protocol issue by including an understanding of high-level service and security requirements about the specific IP network under test from the network administrators.

### CROSS-REFERENCE TO RELATED APPLICATIONS

This application claims the benefit of the filing date of U.S. Provisional Patent Application No. 60/843,894, filed Sep. 12, 2006, the disclosure of which is hereby incorporated herein by reference.

### GOVERNMENT LICENSE RIGHTS

This invention was partially funded with Government support under DARPA contracts no. F30602-00-C-0173 and no. F30602-00-C-0065 and Department of Homeland Security contract no. NBCHC050092.

### FIELD OF THE INVENTION

The present invention concerns rigorous and non-intrusive assessment of IP device configurations to detect device configuration errors that impact security and policy compliance of IP networks.

### BACKGROUND OF THE INVENTION

The rapid increase in the use of IP networking technology for all forms of communications has led to an explosion in the number and types of devices (e.g. routers, firewalls, switches, VPN concentrators, etc) used in an enterprise IP network. These IP networks must satisfy stringent security, reliability, Quality of Service (QoS) and connectivity requirements, to support critical and real-time applications. The IP devices are generally sourced from multiple vendors, with no uniform process or format for their configuration. At the same time, the significant trend towards reducing network operating costs is limiting the level of resources available for correct configuration of the IP network devices. Errors inevitably creep into the device configurations, which may impact not just the security of the network, but also can result in non-compliance with desired network and security requirements.

Technology for assessing whether an IP network satisfies the security and service requirements has not evolved significantly. The current norm for assessing is invasive scanning and controlled launch of actual attacks for detecting security vulnerabilities, and using “ping” or “traceroute” for detecting connectivity issues. Such “active” assessment is not useful for detecting reliability issues, such as detecting a single point-of-failure in the network. Moreover, such assessment does not indicate root-cause of requirement non-satisfaction, it is inherently sampling-based and hence not exhaustive, can be disruptive for the network, and can be inconclusive since results can vary based on current network conditions. Current assessment techniques also cannot diagnose errors arising out of the interactions between security, connectivity, QoS and reliability.

Other existing solutions that analyze device configurations focus on single devices only, and do not consider end-to-end properties of the network. They also tend to focus on validating simplistic firewall and access control rules, and are completely incapable of validating the complex interactions between security and other network properties such as fault tolerance, QoS, and service reachability.

### SUMMARY OF THE INVENTION

Today's IP network, with its responsibility for transporting real-time and mission-critical traffic, can no longer be considered a “Best-Effort” infrastructure. Fool-proof assurances are necessary about the ability of the IP network to satisfy Security, Regulatory and Availability requirements. The present invention relies on customizable software that provides these assurances by comprehensive vulnerability and compliance assessment of IP networks through automated analysis of configurations of devices such as routers, switches, and firewalls.

Key benefits of the invention are:

Reduce Vulnerabilities: 65% of cyber attacks exploit systems with vulnerabilities introduced due to configuration errors, according to Gartner. IP network security can be significantly improved if configuration errors can be pro-actively detected. The invention detects configuration errors efficiently by automating what was previously a difficult and manually intensive task.

Ensure Compliance with Security, Regulatory (FISMA, SOX, HIPAA, PCI) and Availability Requirements: Today it is almost impossible to answer the simple question: “Is my IP network, as currently configured, compliant with my requirements?” The present invention provides this answer by allowing assessors to quickly and completely assimilate the network configuration in its entirety, and evaluate its compliance with end-to-end requirements.

Reduce Network Downtime: Configuration errors are the cause of 62% of network downtime, according to the Yankee Group. The invention reduces downtime by detecting errors before configuration changes are applied to the network devices.

Enable IP Network Situational Awareness: Device configurations are the “DNA” of the network. The present invention provides multi-level visualizations of the entire network, such as physical and IP subnet connectivity, Virtual LAN, routing, and VPN topology. The invention also provides a querying capability to determine service reachability between nodes and networks, Quality of Service on network paths, and single point-of-failures.

Other products use intrusive scanning, link monitoring or device polling techniques, perform piecemeal single-device configuration analysis at best, or rely on resource-intensive simulation techniques. In contrast, the present invention relies on first-order logic-based algorithms for efficient and non-intrusive assessment and visualization of entire IP networks covering multiple devices and protocols.

The server of the present invention can be accessed securely from web-browsers such as Internet Explorer and Firefox, with separate accounts provided for individual users. Device configurations can be up-loaded using the web-based GUI, or can be periodically down-loaded directly from the devices. A range of devices used in today's IP networks are supported. The assessments include a large knowledge-base of Best-Current-Practices, regulations, and invariants for most IP protocols and technologies, and customer-specific requirements. Simpler customer-specific requirements can be input using the intuitive GUI, while more complicated requirements can be input by leveraging the expressiveness of Prolog. Debugging of the device configurations is simplified due to multi-level visualizations of the IP network based on configuration analysis, which is more accurate since they do not depend on instantaneous and ephemeral network state obtained by scanning, link monitoring or device polling techniques. The software can be used periodically, and on-demand such as before making configuration changes. The software can be used directly by enterprises, and by third-parties acting as a Value-Added-Reseller of the invention or the invention-based service to their customers.

The invention is a novel approach for rigorous and non-intrusive testing of IP device configurations to detect device configuration errors that impact security and policy compliance of IP networks. The approach validates static constraints based on Best Current Practices and Belief Sets that are generic for any IP network, and policies/requirements that are specific to each IP network.

Our solution comprises three main approaches for testing of IP device configurations to eliminate errors that result in vulnerabilities or requirements compliance issues. The first two fall in to the “static constraint validation” category since they do not change significantly for each IP network, while the last approach involves incorporation of each specific IP network's policies/requirements. These approaches are complementary, and may be used together to satisfy all the properties described above.

The first approach involves checking the configurations of devices for conformance to Best-Current-Practices put out by vendors (e.g. Cisco Network Security Policy) and organizations such as the NIST, NSA or CERT. Also this includes checks of compliance with regulations such as FISMA, SOX, HIPPA, PCI, etc. The second approach is where as one reads device configurations, one collects beliefs about network administrator intent. As each belief is collected, an inference engine checks whether the new belief is inconsistent with previously accumulated ones. The third approach addresses the multiple device/protocol issue by including an understanding of high-level service and security requirements about the specific IP network under test from the network administrators.

The use of configurations of network devices for various purposes across multi-vendor devices and for configuration assessment for regulatory and security complaince is the improvement provided by the present invention.

The invention will more clearly be understood when the following description is read in conjunction with the accompnaying drawings.

### BRIEF DESCRIPTION OF THE DRAWINGS

FIG. 1 is a schematic block diagram of a web-based client server architecture of the present invention for checking the configurations of devices and for conformance to Best-Current-Practices provided by vendors and organizations.

FIG. 2 shows a flow chart of an application of the invention.

FIG. 3 shows the overall concept of the system comprising the invention and its relationship to other software systems.

### DETAILED DESCRIPTION

An analogy can be drawn between IP network deployment and the software creation. Both start with a high-level set of end-user requirements that need to be delivered. Both end with a working system that supposedly delivers securely the stated requirements. Software creation has evolved over the years to be a fairly well-understood and documented process where multiple steps are followed systematically to reduce errors (bugs) in the end-product. The high-level requirements are translated into modules, with algorithms for each module that are developed into source code. IP network deployment is relatively new, with the IP network design and the IP network device configuration phases considered analogous respectively to the algorithm design and software development phases in software creation.

In software creation, the development phase is followed by a testing phase that can require as much as 25% to 50% effort as the actual code development. The testing phase can involve active testing with data, and analysis of the source code. Current IP network deployment processes lack such a rigorous testing and evaluation phase in most environments, as discussed above. The end-result is that the network deployment is deemed “successful” as soon as traffic “flows” in the normal operating case, but problems impacting security, fault tolerance and QoS attributable to configuration errors do not manifest until the network is under stress or attack.

Our solution comprises three main approaches for testing IP device configurations to eliminate errors that result in vulnerabilities or requirements compliance issues. The first two fall in to the “static constraint validation” category since they do not change significantly for each IP network, while the last approach involves incorporation of each specific IP network's policies/requirements. These approaches are complementary, and may be used together to satisfy all the properties described above.

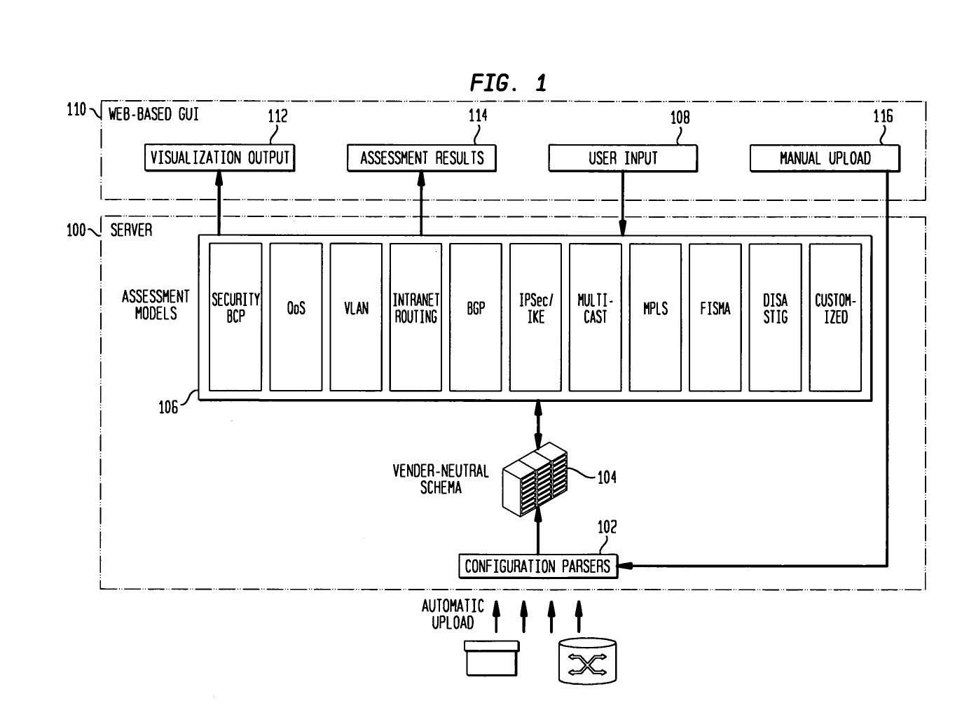

The first approach, shown in FIG. 1, involves checking the configurations of devices for conformance to Best-Current-Practices provided by vendors (e.g. Cisco Network Security Policy) and organizations such as the NIST, NSA or CERT. Also this includes checks of compliance with regulations such as FISMA, SOX, HIPPA, PCI, etc. IP configuration information is automatically uploaded from the network (not shown) to a server 100. The server comprises configuration parsers 102 for multiple vendors and device types which parse real-time input from router-registries and route monitors for BGP. The output of the configuration parsers is provided to a relational database using a vendor-neutral schema 104. Generic representations of IP devices enable the same schema to be used for multiple device-types and vendors. Assessment Modules 106 contain Best-Current-Practices and regulatory compliance information provided by vendors and orgainizations. User input 108 is provided from a Web-based GUI 110. The results of the checking performed in the Assessment Modules 106 is provided to a visualization output 112 where an administrator can see the results of the check, for example, on a screen. The results of the check is also provided as assessment results 114, which presents the administrator with an assessment of results and possible adjustments to be made to the network configuration. This kind of check can be considered equivalent to static analysis of source-code where common errors such as buffer-overflows are detected. Tools such as RAT (Router Assessment Tool) implement such checks to a limited extent for single-device configurations. No apriori knowledge about the specific IP network environment is required. As an alternative to automatic uploading of IP configuration information, the configuration information may be provided to the configuration parsers 102 manually, such as from an input device 116.

The second approach is as follows: as one reads device configurations, one collects beliefs about network administrator intent. As each belief is collected, an inference engine checks whether the new belief is inconsistent with previously accumulated ones. If so, a configuration error is detected. This approach has two advantages. Firstly, it possible to detect contradictions in network administrator intent without knowing what that intent is. The inference engine we use in one embodiment is a combination of Prolog and Alloy. Alloy is a full-first-order logic system that uses SAT satisfiability solvers to find models of formulas. A set of formulas is inconsistent if it has no model. Secondly, Alloy makes it possible to detect contradictions even when complete information about component configurations is not available. For example, if two routers have static routes with the same address as the next hop, then they must both be directly connected to a third router with that address. However, if a next hop originates at a serial interface, a contradiction is obtained since only two routers, not three, can be directly connected via a serial link. This contradiction is obtained without requiring any configuration information about the third router.

Network administrators find information about such contradictions very useful since it is precisely these contradictions that need to be resolve in the first place. This idea is loosely based on that for diagnosing bugs in software, and hinges on the creation of a knowledge base of rules that associate configurations with beliefs. These rules and associated configurations can be obtained by a systematic analysis of protocol intent and assumptions that these protocols make to achieve their goals. Furthermore, it is not necessary for these rules to be perfect or complete. In the absence of any systematic methods for automatically compiling end-to-end service and security requirements into device configurations, identification of any significant configuration errors is useful. As new rules are discovered, they are added to the existing belief set, which improves the effectiveness of the configuration analysis.

A general heuristic for identifying such rules is the following: in general a group of devices executing a protocol have a joint goal to achieve. Two questions are asked: first, how should the components be configured to achieve that joint goal, and second, what assumptions does this group make on other groups to succeed in achieving that joint goal. Answers to these two questions enable the generation of sets of rules; Table 1 lists some examples of beliefs.

TABLE 1
Examples of Beliefs (not an exhaustive list)

| Configuration | | Generated Belief(s) |
|---|---|---|
| 1. | An IPSec tunnel filter on a gateway | Any internal firewalls leading up to R |
| | router R specifies that traffic between | must permit traffic between S and D |
| | source address S and destination address | There is a static route on R for destination |
| | D must be encrypted. | D. |
| 2. | IPSec tunnel originates at a router R and | Tunnel is replicated at all routers in that |
| | R is part of an HSRP cluster. | cluster |
| 3. | A router R has a static route with a next | R is directly connected to a router with an |
| | hop address A. | interface with address A |
| 4. | An interface is of a certain Layer-2 type. | All directly connected interfaces have the |
| | | same Layer-2 type |
| 5. | There exists a firewall cluster. | Each firewall in cluster has identical set of |
| | | rules |
| 6. | A router has an HSRP group configured. | There are at least two routers in the HSRP |
| | | group |
| | | All interfaces in this group use same |
| | | virtual address |

The third approach addresses the multiple device/protocol issue by including an understanding of high-level service and security requirements about the specific IP network under test from the network administrators. These requirements are then implemented in a first-order logic language such as Prolog, and the device configurations are validated against these requirements to detect any violations or inconsistencies. This approach can be considered the equivalent of specification-based analysis and requirements testing of software, and requires significant customization for each target IP network environment.

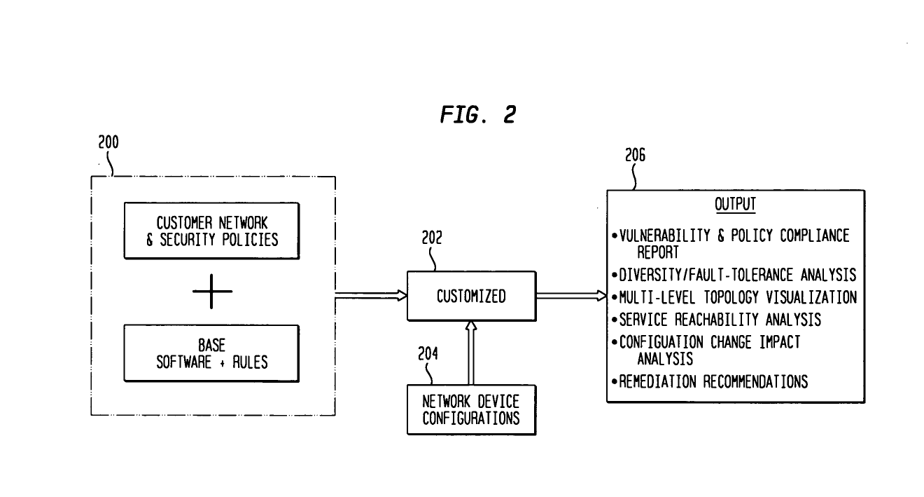

FIG. 2 shows a flow chart of an application of the invention. Customer network and security policies are combined with base software and rules 200. For the third approach, the network administrator supplies the desired customer network and security policies. For the first and second approaches, the base software and rules are a part of the present invention. The combination of the policies and rules is provided to a customized server 202 where the information is combined with the actual network device configurations 204. The output 208 includes one or more of the following: a vulnerability and policy compliance report, a diversity/fault-tolerance analysis, multi-level topology visualization, service reachability analysis, configuration change impact analysis and remediation recommendations.

The outputs are provided in the following preferred ways:

IP Network Assessment using Multi-Device and Multi-Protocol Configuration Analysis: Approach for detecting configuration errors in IP Networks by non-intrusive analysis of configurations of IP network devices. Analysis considers multiple devices and protocols, and is not single-device or single-vendor specific. Analysis used for detecting errors impacting security, reliability, regulatory compliance, and quality of service.

Multi-level Topology Visualization: Graph visualization algorithms from the GraphViz suite are used to depict the topology of the network at multiple levels such as the physical, IP, routing, and IPSec VPN levels. The system provides GraphViz with appropriate node and link information, and uses GraphViz algorithms to generate topology. This provides a multi-level perspective about the network to the administrator, enabling detection of topology ambiguities such as the existence of a link connecting two devices when the connection was not expected. GraphViz is freeware available at www.graphviz.org.

Large IP Topology Visualization: Approach to solve the problem of visualizing large enterprise networks based on the recognition that large IP networks tend to follow a fairly hierarchical IP address allocation. The system captures or aggregates all of the IP addresses in an analysis set, keeps aggregating the IP addresses until there are as many blocks as can be displayed visibly on a screen, shows hi-level connectivity between the blocks. The ability to visualize the connectivity provides an administrator with a more reasonable view of the network. An administrator clicks on a block in the display to drill down to next level of detail. Actual IP connectivity becomes visible only when detail is at level of network devices and links. The visual presentation starts with high-level addresses and goes down a pyramid to view next lower levels of the network.

Diversity/Fault-tolerance testing: An algorithm detects connectivity and single point-of-failure between any two IP addresses in the network. This capability is useful for improving the diversity and hence the fault tolerance of the network. At a high level, the algorithm for single point of failure for IP reachability with firewalls works as follows. First, a bipartite IP connectivity graph RSG is constructed from network configuration data. The vertices of RSG correspond to IP devices (such as routers, switches and firewalls) and subnets, and the edges correspond to interfaces connecting IP devices to subnets.

Packet filtering rules are then associated with each filtering IP device vertex in the RSG. Next, an auxiliary bipartite gateway zone graph GWZ is constructed, wherein a set of IP devices and subnets in RSG are combined into a single zone vertex if any vertex in the set can be reached from any other vertex by following a path in RSG that does not traverse a filtering IP device (connected components). Computed zone memberships for each IP device and subnet are stored. Typically, a GWZ has many fewer nodes than the RSG.

Now, a service reachability problem can be solved as follows. If the source and destination IP addresses belong to the same zone, the destination address can be reached from the source by definition of a zone. If the two addresses belong to different zones, a depth-first search in the GWZ is initiated, where each traversal of a firewall vertex includes a check against the filtering rules associated with the vertex. If the rules would allow a packet to pass, the search continues, otherwise it backtracks. If a path is found, the source is reachable from destination.

Once the path in the GWZ is found and marked, an (arbitrary) path inside each zone on the path can be computed by switching back to the RSG. The result is a complete IP reachability path. Next, each IP device on the latter path is analyzed as a potential single point of failure. We consider deletion of the IP device from the original RSG and attempt to find a path between the source and destination vertices using the reachability algorithm above. If such a path cannot be found, the router is a single point of failuire with respect to the given source and destination vertices.

Network Connectivity Metric and Trends: Performs Diversity/Fault Tolerance Testing on all pairs of IP addresses in network. Computes how many pairs are reachable, and how many have single points-of-failure by performing an assessment of every pair of nodes in the network to determine how good is the connectivity of the network. The assessment is performed over time by repeating the algorithm. This represents the Network Connectivity Metric. Changes in the metric are compared on a regular basis to determine the trend in this metric.

Configuration change impact analysis: The user can add/delete/modify configurations and probe the effects of the change by loading them into the software system and carrying out the previously described analyses. This capability enables the “testing” of configuration changes before they are deployed in to the network, reducing the impact of errors on the operational network.

Internal, External and DMZ Realms: Approach to solve the problem of allowing the network/security administrator to convey how the network is partitioned into various realms, such as internal, de-militarized zone (DMZ), and external (can be more than 3). Administrator defines and names realms on IP subnet topology visualization through system GUI. System automatically labels all IP interfaces in each realm with segment names, provides an administrator with automatically generated lists of IP interfaces in each defined realm. The nodes or subnets are divided into different named buckets which are used to assess the requirements of each portion of the network as represented by the nodes in a respective bucket. The nodes or subnets may be updated periodically, particularly whenever new devices or subnets are added to or removed from the network. That is, the administrator can change/add/delete associations of interfaces to realms made by system. Realm labels are used by the system in assessments.

Analysis Sets: Approach to provide flexibility for the administrator to choose the devices and configuration versions to be assessed by the system. Chosen devices and versions can be saved as a custom set by the administrator for later use. The system also provides a default set, such as a set of the latest configurations versions of all devices.

Assessment Suite: Choosing sub-sets of rules sets as specific assessment suites for running against chosen analysis set.

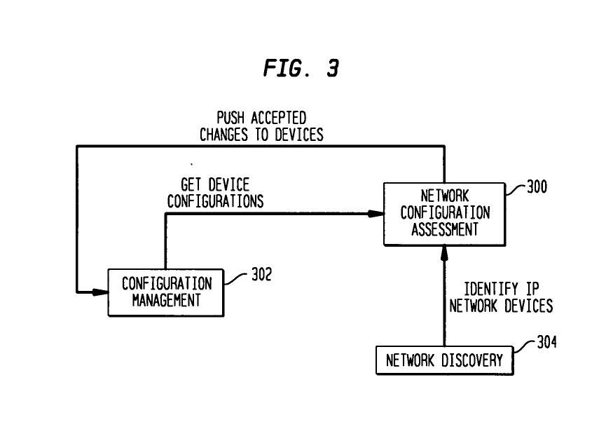

FIG. 3 shows the overall concept of the system comprising the invention and its relationship to other software systems. The IP Network Configuration Assessment server 300 comprising the present invention receives device configuration information from Configuration Management system 302 and also receives the identification of IP network devices from Network Discovery system 304. As a result of applying the IP Network Configuration Assessment comprising the present invention, accepted changes to devices are pushed into the Configuration Management system thereby changing the device configurations.

While there has been described and illustrated a method and system for IP network vulnerability and policy compliance by IP device assessment, it will be apparent to those skilled in the art that further modifications and variations are possible without deviating from the spirit and broad teaching of the present invention which shall be limited solely by the scope of the claims appended hereto.

What is claimed is:

1. An IP network policy compliance assessment method comprising the steps of:
providing network device configurations;
checking device configurations for conformance to predetermined best-current-practices and/or regulatory compliance; and
assessing the results of said checking and providing an indication of the assessment.

2. An IP network policy compliance assessment method comprising the steps of:
reading IP network device configurations;
accumulating beliefs about network administrator intent; and
assessing whether each new belief is consistent with the previously accumulated beliefs.

3. An IP network policy compliance assessment method comprising the steps of:
combining network and security policies with rules;
combining network device configurations with the combined network and security policies and rules; and
providing outputs based on assessing network and security rules against the network device configurations.

4. An IP network policy compliance assessment method as set forth in claim 3, wherein the outputs are obtained using multi-device and multi-protocol configuration analysis.

5. An IP network policy compliance assessment method as set forth in claim 3, wherein the outputs are obtained using multi-level topology visualization.

6. An IP network policy compliance assessment method as set forth in claim 3, wherein the outputs are obtained using large IP topology visualization.

7. An IP network policy compliance assessment method as set forth in claim 3, wherein the outputs are obtained using diversity/fault-tolerance testing.

8. An IP network policy compliance assessment method as set forth in claim 7, wherein the outputs are obtained using network connectivity metric and trends.

9. An IP network policy compliance assessment method as set forth in claim 3, wherein the outputs are obtained by partitioning the IP network in a plurality of realms.

10. An IP network policy compliance assessment method as set forth in claim 9, wherein the realms are selected from the group consisting of internal, external and de-militarized realm.

11. An IP network policy compliance assessment method as set forth in claim 3, wherein the outputs are obtained using at least one analysis set.

12. An IP network policy compliance assessment method as set forth in claim 3, wherein the outputs are obtained using at least one assessment suite.

13. A system for IP network policy compliance assessment comprising:
configuration parsers receiving IP network configuration data for multiple device types and vendors for parsing real-time input from route-registries and route markers;
a relational database coupled to said configuration parsers using a vendor-neutral schema for multiple device types and vendors; and
assessment modules containing best-current-practices and/or regulatory compliance information for assessing IP network configuration.

14. A system for IP network policy compliance assessment as set forth in claim 13, wherein the network configuration data is automatically uploaded from an IP network.

15. A system for IP network policy compliance assessment as set forth in claim 13, wherein the network configuration is manually provided to said configuration parsers.

16. A system for IP network policy compliance assessment as set forth in claim 13, further comprising means for visually displaying the assessment.

17. A system for IP network policy compliance assessment as set forth in claim 13, wherein the assessment includes results and possible adjustments to be made to the network configuration.

18. A system for IP network policy compliance assessment as set forth in claim 13, wherein user input is provided to said assessment modules.
